(19) United States
(12) Patent Application Publication
(10) Pub. No.: US 2010/0116098 A1
(43) Pub. Date: May 13, 2010

(54) ANTI-SLIP ASSEMBLY ELEMENT FOR HAND TOOL

(76) Inventor: Teng Yuan KUO, Taichung County (TW)

Correspondence Address: Chien-Hui Su, P. O. Box 70-121 Taichung, Taichung City, 40899, TW

(21) Appl. No.: 12/686,313

(22) Filed: Jan. 12, 2010

Related U.S. Application Data
(63) Continuation-in-part of application No. 12/015,517, filed on Jan. 17, 2008, now abandoned.

(51) Int. Cl. B25B 13/06

(52) U.S. Cl. 81/121.1

(57) ABSTRACT

An anti-slip assembly element for hand tool includes an assembly element adapting to be detachably connected to a hand tool. The assembly element has a polygonal portion formed on one end thereof. A plurality of anti-slip portion is respectively disposed between every two adjacent side walls of the polygonal portion. Each anti-slip portion has a plurality of first grooves parallely defined therein and a plurality of second grooves parallely defined therein. The first grooves are crosswise of the second grooves. When a user grasps the polygonal portion of the assembly element, the anti-slip portions provides a friction for easily gripping. When the assembly element is dropped down, the anti-slip portions provide the friction for avoiding rolling away.

### CROSS-REFERENCE TO RELATED APPLICATION

This application is a Continuation-in-part Application of Ser. No. 12/015,517, filed 17 Jan. 2008, and entitled “ANTI-SLIP ASSEMBLY ELEMENT FOR HAND TOOL”, now pending.

### BACKGROUND OF THE INVENTION

1. Field of the Invention

The present invention relates to an anti-slip assembly element for hand tool, and more particularly to a structure for avoiding an undesired rolling as well as for achieving an easy grip and a rapid tightening. Moreover, it serves as an identification label for an easy identification of the item number, size, type, etc.

2. Description of Related Art

The assembly element for hand tool includes accessories of force-applying hand tools such as a socket, a connecting bar, an adapter, a universal joint, a compression socket, etc. The force-applying hand tools may be screwdrivers, wrenches, ratchets, etc. After the anti-slip element assembles with the hand tool, the screws can be tightened by operating the assembled hand tool. In considering an easy and economical production, every existing assembly element includes a smooth cylindrical body at the largest part thereof. That is, the part held by the operator is formed as a smooth cylindrical body.

The structure mentioned above has been adopted for decades, and the operators are also accustomed thereto. However, this part which is formed as a cylindrical body causes an undesired rolling displacement when it lies on a surface. Therefore, the operator has to pay attention to its position. Even, its search requires the attention of the operator, thereby causing much inconvenience and delay of the work. Moreover, the fingers of the operator can be greasy when working under an oily operation environment so that the operator can not hold the assembly element with a smooth surface properly. As a result, an unexpected slip often takes place. Meanwhile, the operator can not perform a rapid tightening process with his fingers. Thus, the conventional structure requires further improvements.

### SUMMARY OF THE INVENTION

A first objective of the present invention is to provide an improved anti-slip assembly element for hand tool and to change the form and the structure of the largest part of the assembly element such that the above-mentioned drawbacks of the conventional products can be eliminated while the convenience and the practicalness of the present invention are ensured.

A second objective of the present invention is to provide an anti-slip assembly element for hand tool that includes at least one annular groove formed in the largest portion thereof as an identification label for an easy identification of the item number, size, type, etc.

According to the present invention, the anti-slip assembly element for hand tool includes a polygonal portion formed on the largest part thereof, which can be quadrangular, hexagonal, octagonal, etc. A plurality of anti-slip portion is respectively disposed between every two adjacent side walls of the polygonal portion. Each anti-slip portion has a plurality of first grooves parallely defined therein and a plurality of second grooves parallely defined therein. The first grooves are crosswise of the second grooves. The anti-slip portions provide for avoiding an undesired rolling as well as for achieving an easy grip and a rapid tightening.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a first embodiment of an anti-slip assembly element for hand tool in accordance with the present invention;

FIG. 2 is a side view of the first embodiment of the present invention according to FIG. 1;

FIG. 3 is a perspective view of a second embodiment of the anti-slip assembly element for hand tool in accordance with the present invention;

FIG. 4 is a perspective view of a third embodiment of the anti-slip assembly element for hand tool in accordance with the present invention;

FIG. 5 is a perspective view of a fourth embodiment of the anti-slip assembly element for hand tool in accordance with the present invention;

FIG. 6 is a perspective view of a fifth embodiment of the anti-slip assembly element for hand tool in accordance with the present invention;

FIG. 7 is a perspective view of a sixth embodiment of the anti-slip assembly element for hand tool in accordance with the present invention;

FIG. 8 is a perspective view of a seventh embodiment of the anti-slip assembly element for hand tool in accordance with the present invention; and

FIG. 9 is a partially enlarged view of an anti-slip portion of an anti-slip assembly element in accordance with the present invention in FIG. 1.

### DETAILED DESCRIPTION OF THE INVENTION

The present invention will now be described in more detail hereinafter with reference to the accompanying drawings that show various embodiments of the present invention.

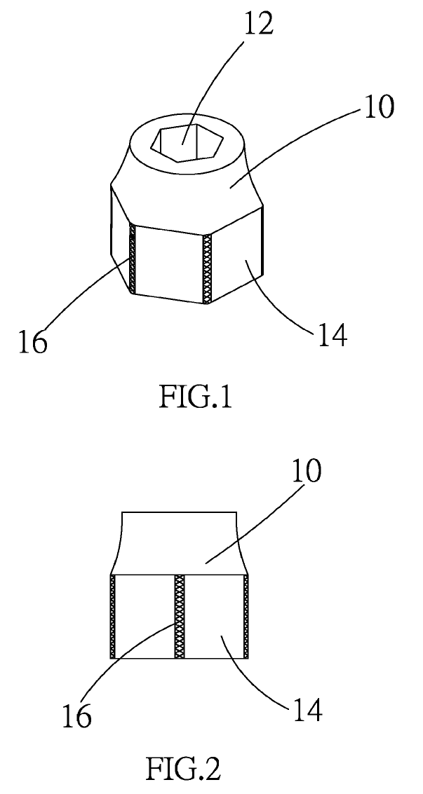

Referring to the drawings and initially to FIGS. 1-2, an anti-slip assembly element for hand tool in accordance with a first embodiment of the present invention is a socket 10 which is detachably connected to a hand tool (not shown). The socket 10 has a tool insertion hole 12 defined in one end thereof The socket 10 has a polygonal portion 14 formed on the other end thereof. The polygonal portion 14 has an outer diameter greater than an outer diameter of the rest of the socket 10.

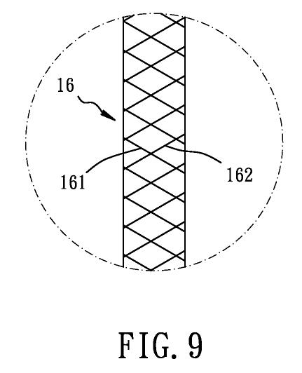

A plurality of anti-slip portion 16 is respectively disposed on an outer periphery of the polygonal portion 14 and lengthwise located between every two adjacent side walls of the polygonal portion 14. As shown in FIG. 9, each anti-slip portion 16 has a plurality of first grooves 161 parallely defined therein and a plurality of second grooves 162 parallely defined therein. The first grooves 161 are crosswise of the second grooves 162.

When a user grasps the polygonal portion 14 of the socket 10, the first and second grooves 161, 162 on the anti-slip portions 16 provide a friction for easily gripping. When the socket 10 is dropped down, the first and second grooves 161, 162 on the anti-slip portions 16 provide the friction for avoiding rolling away.

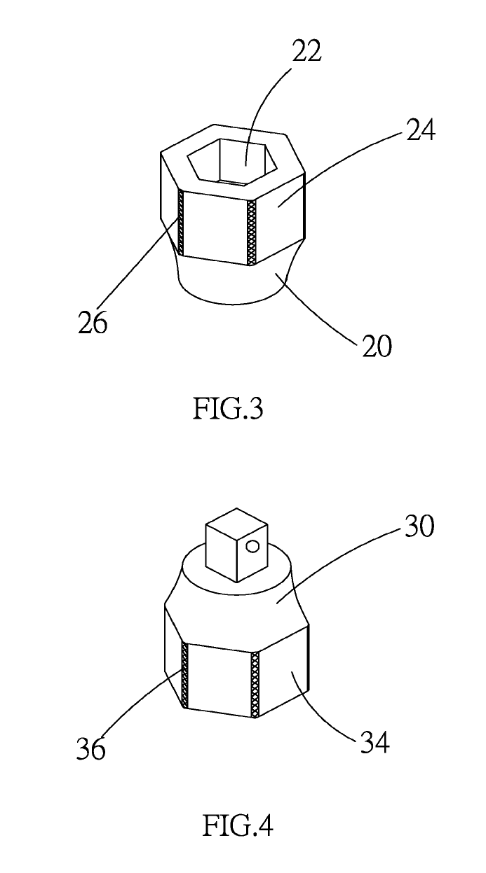

With reference to FIG. 3, that shows a second embodiment of the anti-slip assembly element for hand tool in accordance with the present invention. In this embodiment, the assembly element is another socket 20. The socket 20 includes a tool insertion hole 22 defined in one end thereof A polygonal portion 24 is formed on the other end of the socket 20. The polygonal portion 24 has an outer diameter greater than an outer diameter of the rest of the socket 20.

A plurality of anti-slip portion 26 is respectively disposed on an outer periphery of the polygonal portion 24 and lengthwise located between every two adjacent side walls of the polygonal portion 24. Each anti-slip portion 26 has a plurality of first grooves (not numbered) parallely defined therein and a plurality of second grooves (not numbered) parallely defined therein. The first grooves are crosswise of the second grooves.

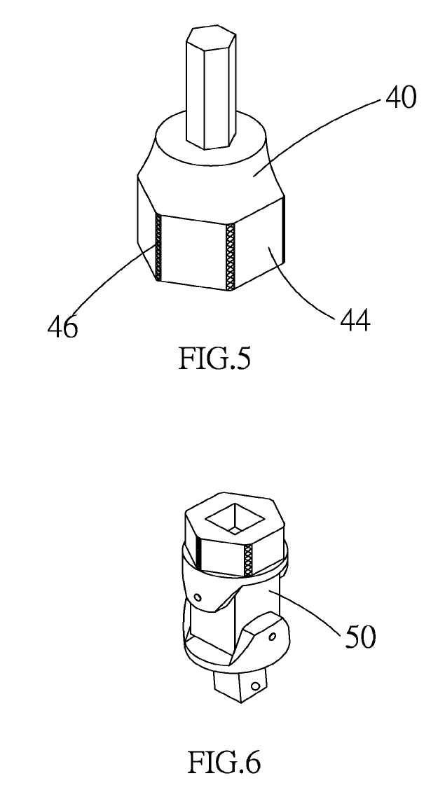

With reference to FIGS. 4 and 5, those respectively show a third and a fourth embodiments of the anti-slip assembly element for hand tool in accordance with the present invention. In the third embodiment, the assembly element is an adapter 30. In the fourth embodiment, the assembly element is a compression socket 40. Likewise, a polygonal portion 34, 44 is formed on one end of the assembly element 30, 40. The polygonal portion 34, 44 has an outer diameter greater than an outer diameter of the rest of the assembly element 30, 40.

A plurality of anti-slip portion 36, 46 is respectively disposed on an outer periphery of the polygonal portion 34, 44 and lengthwise located between every two adjacent side walls of the polygonal portion 34, 44. Each anti-slip portion 36, 46 has a plurality of first grooves (not numbered) parallely defined therein and a plurality of second grooves (not numbered) parallely defined therein. The first grooves are crosswise of the second grooves.

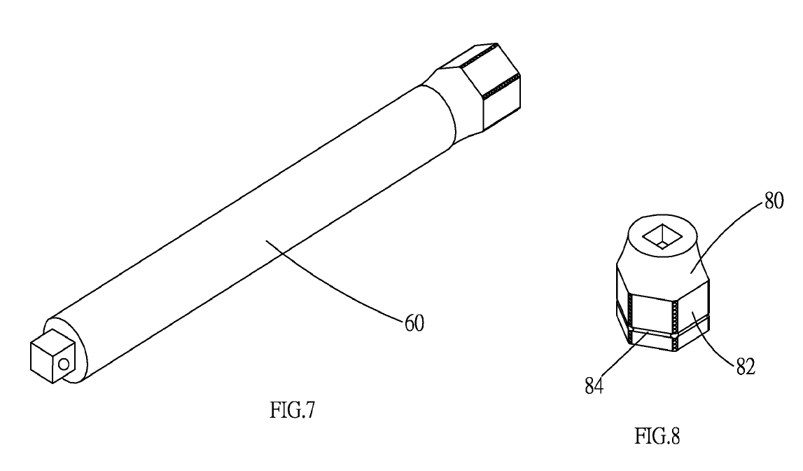

With reference to FIGS. 6 and 7, those respectively show a fifth and a sixth embodiments of the anti-slip assembly element for hand tool in accordance with the present invention. In the fifth embodiment, the assembly element is a universal joint 50. In the sixth embodiment, the assembly element is an extension bar 60. Each of the two embodiments also includes the features of the present invention mentioned above.

With reference to FIG. 8, that shows a seventh embodiment of the anti-slip assembly element for hand tool in accordance with the present invention. In this embodiment, the assembly element is any one socket 80 mentioned above. The socket 80 has a polygonal portion 82 formed on one end thereof. The polygonal portion 82 has an outer diameter greater than an outer diameter of the rest of the socket 80. The polygonal portion 82 has at least one annular groove 84 defined in the outer periphery thereof The at least one annular groove 84 can be filled with a colored paint (not shown) as an identification label for an easy identification of the item number, size, type, etc.

The anti-slip assembly element of the present invention has a wide application scope and includes almost all of the assembly elements for hand tools. It is difficult to show all of them with drawings. As a result, any elements that are added or equivalent to the present invention should all fall within the scope of the present invention.

Many changes and modifications in the above-described embodiments of the present invention can, of course, be carried out without departing from the scope thereof. Accordingly, to promote the progress in science and the useful arts, the present invention is disclosed and is intended to be limited only by the scope of the appended claims.

What is claimed is:

1. An anti-slip assembly element for hand tool comprising:
an assembly element adapting to be detachably connected to a hand tool, the assembly element having a polygonal portion formed on one end thereof; and
a plurality of anti-slip portion respectively disposed on an outer periphery of the polygonal portion and lengthwise located between every two adjacent side walls of the polygonal portion, each anti-slip portion having a plurality of first grooves parallely defined therein and a plurality of second grooves parallely defined therein, the first grooves being crosswise of the second grooves;
wherein when a user grasps the polygonal portion of the assembly element, the anti-slip portions provides a friction for easily gripping; when the assembly element is dropped down, the anti-slip portions provide the friction for avoiding rolling away.

2. The anti-slip assembly element for hand tool as claimed in claim 1, wherein the polygonal portion has at least one annular groove defined in the outer periphery thereof.

3. The anti-slip assembly element for hand tool as claimed in claim 1, wherein the assembly element is a socket.

4. The anti-slip assembly element for hand tool as claimed in claim 1, wherein the assembly element is an adapter.

5. The anti-slip assembly element for hand tool as claimed in claim 1, wherein the assembly element is a compression socket.

6. The anti-slip assembly element for hand tool as claimed in claim 1, wherein the assembly element is an universal joint.

7. The anti-slip assembly element for hand tool as claimed in claim 1, wherein the assembly element is an extension bar.
